(19) United States
(12) Patent Application Publication
(10) Pub. No.: US 2015/0135690 A1
(43) Pub. Date: May 21, 2015

(54) SYSTEM FOR RECOVERING ENERGY IN AN EXHAUST GAS CIRCUIT

(71) Applicant: Valeo Systemes de Controle Moteur, Cergy Saint Christophe (FR)

(72) Inventors: Grégory Hodebourg, Sartrouville (FR); Samuel Leroux, Poissy (FR)

(21) Appl. No.: 14/398,983

(22) PCT Filed: Apr. 26, 2013
(86) PCT No.: PCT/FR2013/050935

§ 371 Date: Nov. 5, 2014

(30) Foreign Application Priority Data
May 9, 2012 (FR) 1254192

(51) Int. Cl. F02G 5/04; F01N 5/02

(52) U.S. Cl. CPC F02G 5/04; F01N 5/02
USPC 60/320

(57) ABSTRACT

The invention relates to a system for recovering energy in an exhaust gas circuit (3) of a heat engine (1) of a vehicle, said system comprising an exhaust gas bypass duct (15) comprising a heat exchanger (18). An energy recovery system according to the invention is mainly characterised by the fact that the part of the exhaust circuit arranged downstream of the connection point (17) of the bypass duct (15) for connecting to said circuit (3) is provided with a valve (16) that can at least partially close the exhaust circuit (3), and the by-pass duct (15) comprises, at the outlet of the exchanger (18), a first pipeline (20) running into the admission circuit (2, 6) and a second pipeline (21) running into the exhaust circuit (3) downstream of the valve (16).

The invention relates to an energy recovery system in an exhaust gas circuit. The framework of the invention is that of heat engines for cars which generally require incident gases to ensure satisfactory combustion in each combustion chamber in conjunction with the injected fuel, the exhaust gases coming from this combustion being subsequently removed into the atmosphere after being purified. It has emerged that rather than being removed from the vehicle without any particular function, these exhaust gases which have been brought to a certain temperature can be reused within said vehicle in order, for example, to contribute to the heating of the vehicle or to be redirected towards the incident gases, in order to improve the combustion conditions in each of said chambers. The invention relates to an optimized energy recovery system based on the use of these exhaust gases.

There are existing energy recovery devices and procedures which have already been patented. It is possible, for example, to cite patent FR2920834 which relates to a device and procedure involving exhaust gas recirculation in a heat engine. A gas recirculation device of this kind uses a by-pass duct linking the exhaust duct to the intake duct, said duct comprising a heat exchanger for cooling the recycled gases. A problem commonly found with this kind of configuration is that that pressure level of the gases in the exhaust duct is not high enough to allow said gases to reach the exchanger of the by-pass duct with a sufficient flow rate. It follows from this that the amount of exhaust gas redirected towards the intake duct remains scarcely controlled and therefore quite random, making the gas recirculation uncertain.

The energy recovery systems according to the invention are configured to ensure in all circumstances good exhaust gas circulation conditions in a by-pass duct originating in the exhaust circuit and being able, for example, to be used to reheat the passenger compartment of the vehicle or to redirect the exhaust gases in the intake circuit.

In order to understand the characteristics of the invention clearly, it is necessary to underline the fact that the terms “upstream”, “downstream”, “inlet” and “outlet” should be considered in relation to the gas propagation direction. Likewise, the existence of a gas intake circuit and an exhaust gas circuit for a heat engine is assumed.

The object of the invention is an energy recovery system in an exhaust gas circuit of a vehicle heat engine, said system comprising an exhaust gas by-pass duct fitted with a heat exchanger. The main characteristic of an energy recovery system according to the invention is that the part of the exhaust circuit situated downstream of the connection point of the by-pass duct in said circuit is fitted with a valve capable of shutting off the exhaust circuit at least partially. In fact, during the course of certain engine usage phases, the exhaust gas pressure is insufficient to make said gases circulate in the by-pass duct with good flow rate conditions in particular. For these phases, the valve is controlled so that it can be closed and all the exhaust gases are then diverted with sufficient pressure into the by-pass duct fitted with the heat exchanger. Closure of the valve eliminates an escape route for the gases in the escape circuit and therefore increases the pressure of the gases upstream of said valve, which are then going to move into the by-pass duct. The term “valve” is a general one and may designate all kinds of objects or devices capable of opening or closing a gas duct. This valve may, for example, be a metering valve. The by-pass duct is likewise a generic term that may for example designate a duct intended to direct the exhaust gases towards the engine's intake circuit. The heat engine may also consist of a petrol or diesel engine. The fact that the valve can shut off the exhaust circuit completely or partially allows a significant modulation of the flow rate of the gases in the by-pass duct, increasing the range of use of said duct.

The valve advantageously comprises a pivotably mounted flap capable of being fixed in any intermediate position situated between a maximum opening position and a closing position. This possibility allows better control of the flow rate of gases used in the exhaust circuit and therefore in the by-pass duct. In fact, a variable opening valve allows said flow rates to be precisely controlled, particularly depending on the usage phase of the engine.

The exhaust circuit preferably comprises a particle filter located upstream of the connection point of the by-pass duct in said circuit. In most existing exhaust gas circuits, the particle filter is generally inserted upstream of the connection point of the by-pass duct in said circuit. Within the framework of an energy recovery system according to the invention, said filter has been moved back upstream of said connection point, in order to be advantageously replaced by the valve.

The exhaust circuit advantageously comprises a catalytic converter located upstream of the particle filter.

The by-pass duct preferably comprises at the exchanger outlet a first channel opening out into the intake circuit and a second channel opening out into the exhaust circuit downstream of the valve. In other words, the by-pass duct may be used in two different ways: either as a recycling duct which allows the exhaust gases to be introduced into the intake circuit, said gases being more or less cooled by the exchanger in order to mix them with the incident gases themselves, or as an energy recovery duct through the heat exchanger, in order to heat or cool certain liquids in the vehicle.

The by-pass duct advantageously comprises at the exchanger outlet a selection device capable of being controlled, in order to allow the gases emanating from the exchanger to pass either through the first channel or through the second channel. In effect, since the flow rate of exhaust gases is not sufficient to allow the gases at the exchanger outlet to pass simultaneously through the first channel and through the second channel, the selection device is going to favor either the recycling of the exhaust gas towards the intake circuit or the recovery of energy with reinjection of the derived gases in the exhaust circuit.

According to a first preferred embodiment of an energy recovery system according to the invention, the selection device comprises a valve fitted with a single flap mounted pivotably between a first position for which it opens the first channel and closes the second channel and a second position for which it opens the second channel and closes the first channel. It is a compact configuration involving a simplified valve mechanism, using a single shut-off flap.

It is preferential for the flap to pivot between the two positions with a value included between 70° and 90°. This configuration is easy to perfect, reliable and well controlled.

The heat exchanger and by-pass valve advantageously constitute a one-piece module. A module of this kind promotes a certain compactness of the assembly made up of the exchanger and said valve.

According to a second preferred embodiment of an energy recovery system according to the invention, the selection device comprises a valve fitted with two rotationally movable flaps, one being placed in the first channel and the other in the second channel, and each of said flaps may be controlled to move from a maximum opening position to a closure position of the channel in which it is inserted. In relation to the preceding configuration which offered as an alternative only one route for the gas, either the first channel or the second channel, this valve configuration adds two additional possibilities corresponding to a simultaneous closure of and simultaneous opening of the two channels.

The two flaps are advantageously controlled independently of one another. This configuration therefore offers a multiplicity of configurations in terms of different gas passages and their associated flow rates. This leads to greater flexibility of use of an energy recovery system according to the invention.

The energy recovery systems according to the invention have the advantage of increasing the pressure of gases in a channel, not by means of an additional energy source, but by shutting off another channel. This means that said systems are compact and inexpensive, while retaining their performance in relation to the intended aim. Moreover, they have the advantage of using valves, the operation of which is well controlled and precise, making the energy recovery systems according to the invention reproducible and reliable.

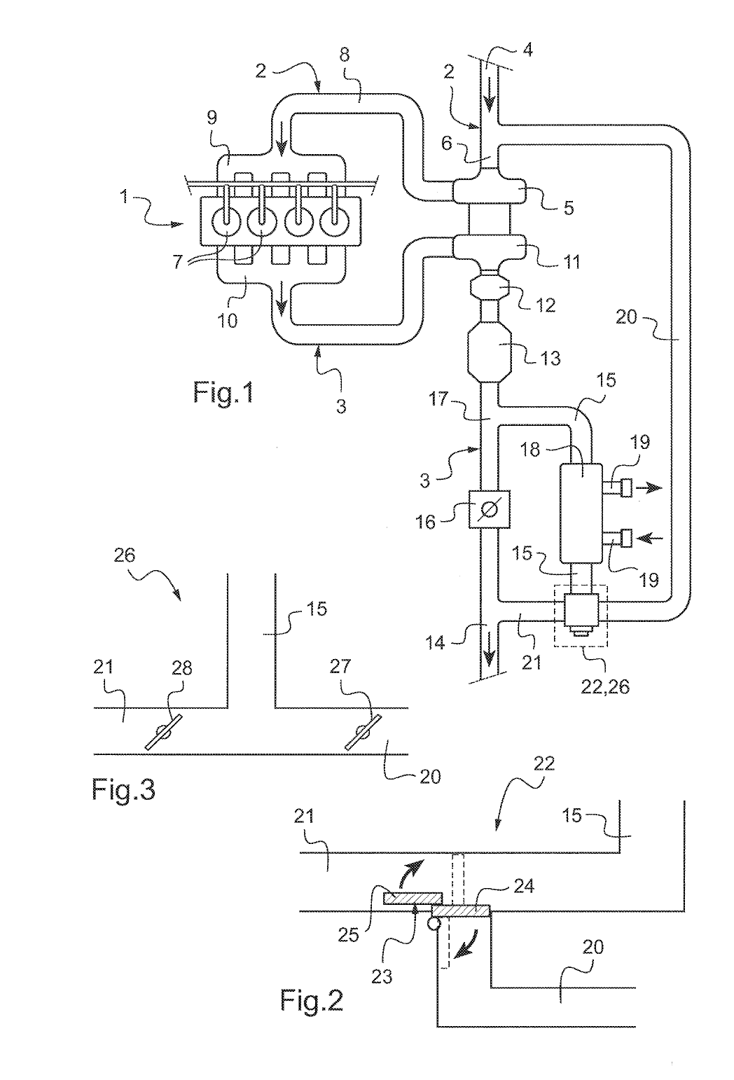

Below is a detailed description of an energy recovery system according to the invention referring to FIGS. 1 to 3.

FIG. 1 is a schematic view of an engine architecture provided with a gas circuit comprising an energy recovery system according to the invention,

FIG. 2 is a schematic view of a first preferred embodiment of a valve fitted in a by-pass duct of an energy recovery system according to the invention,

FIG. 3 is a schematic view of a second preferred embodiment of a valve fitted in a by-pass duct of an energy recovery system according to the invention.

With reference to FIG. 1, a gas circuit of a heat engine 1 comprises an intake circuit 2 situated upstream of said engine 1 and an exhaust circuit 3 situated downstream thereof. The intake circuit 2 schematically comprises an air inlet 4 supplying air to a compressor 5 via an inlet manifold 6, the supplied air coming from said compressor 5 being directed towards the combustion chambers 7 of said engine 1 by means of a supply duct 8. More precisely, this supply duct 8 opens out into an intake distributor 9 allowing air to be distributed into each of the combustion chambers 7 of the engine 1. This air is essential in ensuring good combustion conditions in said chambers 7. The exhaust gases which have been burnt in the chambers 7 are removed by means of an exhaust distributor 10 to direct said gases towards a turbine 11 which is connected to the compressor 5. The gases leaving the turbine 11 are first going to pass into a catalytic converter 12, then into a particle filter 13, so that the exhaust gases are cleaned, the gases coming from said catalytic converter 13 then being able to be directly removed towards the outside of the vehicle through the end section 14 of the exhaust circuit 3 or to pass through a by-pass duct 15 originating in the exhaust circuit 3 downstream of the particle filter 13. The exhaust circuit 3 comprises a valve 16 situated downstream of the connection point 17 of the by-pass duct 15 on said circuit 3, said valve 16 being capable of being controlled to open or close the section of the exhaust circuit 3 in which it is inserted. More precisely, this valve 16 is fitted with a pivoting flap designed to move from a completely open position into a closed position, said flap being capable of being fixed in any intermediate position situated between these two extreme positions. The by-pass duct 15 is equipped with a heat exchanger 18 connected by linking manifolds 19 to a heat-exchanging fluid being able, for example, to be housed in a vehicle radiator, said exchanger 18 serving to cool the exhaust gases passing through the by-pass duct 15. At the outlet of this heat exchanger 18, the by-pass duct 15 is extended by a first system of recycling channels 20 allowing the escape gases to be directed into the air intake circuit 2 at the level of the inlet manifold 6, so that said gases are mixed with the incident air before being sent into the combustion chambers 7 of the engine 1 and by a second channel 21 allowing the gases to be directed into the exhaust circuit 3 downstream of the valve 16. An energy recovery system according to the invention comprises the by-pass duct 15 fitted with the heat exchanger 18 and extended by two systems of channels 20, 21, as well as the valve 16 of the exhaust circuit 3.

With reference to FIG. 2, according to a preferred embodiment of an energy recovery system according to the invention, the by-pass duct 15 has a first valve 22 fitted at the exchanger outlet 18 and allowing the gases to be directed selectively either towards the first channel 20 or towards the second channel 21. This first valve 22 comprises a single flap 23 mounted pivotably about a rotational axis and comprising two sections 24, 25 located on either side of said axis. In a first position, a first portion 24 of the flap 23 opens the first channel 20 and a second portion 25 simultaneously shuts off the second channel 21. In a second position which is deduced from the first position through a 90° rotation (in this example), the first portion 24 of the flap 23 shuts off the first channel 20, whereas the second portion 25 opens the second channel 21. In FIG. 2, the flap 23 is mounted in its second position and can pivot by 90° in the direction indicated by the two arrows, finding itself back in the first position. For this embodiment, the heat exchanger 18 and the first valve 22 constitute a one-piece module, allowing these elements to be compacted among themselves, and therefore reducing the resulting size. This grouping of the exchanger 18 and the first valve 22 in the same single module likewise allows improved handling and enables said exchanger 18 and said first valve 22 to be assembled separately, prior to their assembly on the exhaust circuit 3.

With reference to FIG. 3, according to a second preferred embodiment of an energy recovery system according to the invention, the by-pass duct 15 has a second valve 26 replacing the first valve 22 and positioned at the outlet of the exchanger 18, said second valve 26 allowing the gases to be directed selectively, either towards the first channel 20 or towards the second channel 21. This second valve 26 uses two flaps 27, 28 mounted pivotably, a first flap being positioned in the first channel 20 and a second flap 28 being placed in the second channel 21. Each of said flaps 27, 28 can be controlled independently of one another between a completely open position and a closed position of the channel 20, 21 in which it is inserted. Each flap 27, 28 may be fixed in all the intermediate positions situated between these two extreme positions. This second preferred embodiment of an energy recovery system according to the invention allows two additional configurations to be realized in relation to the first embodiment described above which are, for the one part, a simultaneous closure of the two systems of channels 20, 21 and, for the other part, a simultaneous opening of said systems of channels 20, 21.

An energy recovery system according to the invention may therefore operate in two modes:
An energy recovery mode for which the valve 16 closes the exhaust circuit 3 fully or partially. The exhaust gases pass for the most part through the by-pass channel 15 with an increased flow rate before entering the heat exchanger 18. The valve 22, 26 situated at the outlet of said exchanger 18 allows the gases to be directed in the second channel 21 towards the escape circuit 3 downstream of the valve 16, once said gases have heated a liquid circulating in the exchanger 18.
An exhaust gas recycling mode. If the pressure is sufficient, in the case of an engine on full load, for example, a portion of the exhaust gases naturally passes through the by-pass duct 15 before being directed, thanks to the valve 22, 26 located behind the exchanger 18, towards the intake circuit 2 via the first channel 20. If the pressure is not sufficient, the valve 16 of the exhaust circuit 3 closes at least partially, in order to increase the pressure of the gases in the by-pass duct 15.

1. An energy recovery system in an exhaust gas circuit of a vehicle heat engine, said system comprising:
an exhaust gas by-pass duct fitted with a heat exchanger, a part of the exhaust circuit situated downstream of the connection point of the by-pass duct in said circuit being fitted with a valve capable of shutting off the exhaust circuit at least partially,
wherein the by-pass duct comprises at the exchanger outlet a first channel opening out into the intake circuit and a second channel opening out into the exhaust circuit downstream of the valve.

2. The energy recovery system as claimed in claim 1, the valve comprising a pivotably mounted flap capable of being fixed in any intermediate position situated between a maximum opening position and a closing position.

3. The energy recovery system as claimed in claim 1, the exhaust circuit comprising a particle filter located upstream of the connection point of the by-pass duct in said circuit .

4. The energy recovery system as claimed claim 1, the by-pass duct comprising at the exchanger outlet a selection device capable of being controlled, in order to allow the gases emanating from the exchanger to pass either through the first channel or through the second channel .

5. The energy recovery system as claimed in claim 4, the selection device comprising a valve fitted with a single flap mounted pivotably between a first position for which it opens the first channel and closes the second channel and a second position for which it opens the second channel and closes the first channel.

6. The energy recovery system as claimed in claim 5, the flap pivoting between the two positions with a value of between 70°and 90°.

7. The energy recovery system as claimed in claim 5, the heat exchanger and the valve of the by-pass duct forming a one-piece module.

8. The energy recovery system as claimed in claim 1, the selection device comprising a valve fitted with two rotationally movable flaps, one being placed in the first channel and the other being placed in the second channel, each of said flaps being capable of being controlled to move from a maximum opening position to a closure position of the channel in which it is inserted.

9. The energy recovery system as claimed in claim 8, the two flaps being controlled independently of one another.
